(19) United States
(12) Patent Application Publication
(10) Pub. No.: US 2009/0157451 A1
(43) Pub. Date: Jun. 18, 2009

(54) SYSTEM AND METHOD FOR DETECTING MANIPULATION IN FINANCIAL MARKETS

(75) Inventors: Gregg Katsura Steuben, Clifton Park, NY (US); Janet Arlie Barnett, Paltersonville, NY (US); Christina LaComb, Schenectady, NY (US)

Correspondence Address: GENERAL ELECTRIC COMPANY (PCPI);C/O FLETCHER YODER, P. O. BOX 692289, HOUSTON, TX, 77269-2289, US

(73) Assignee: General Electric Company, Schenectady, NY (US)

(21) Appl. No.: 11/959,332

(22) Filed: Dec. 18, 2007

(51) Int. Cl. G06Q 10/00; G06Q 40/00

(52) U.S. Cl. 705/7; 705/37

(57) ABSTRACT

A technique is presented for detecting manipulation in a market. The technique may be used with a web-based market that enables a plurality of traders to transact or to speculate in an item. A record of each transaction between the traders of the market is stored. The transaction records are accessed and processed to identify transactions representative of a potential manipulation of the market. To identify a potential manipulation of the market, the transaction records are processed to identify transactions between a first trading account established by a trader and a second trading account established as an alias trading account. In addition, the transaction records are processed to identify transaction executed as part of a plan of collusion between two or more traders.

### BACKGROUND

The invention relates generally to financial markets. In particular, the invention relates to a network-based market that enables transactions between traders to be made electronically.

Information markets are also known as “prediction markets,” “speculative markets,” “virtual stock markets,” “artificial markets” and “idea markets.” Information markets are typically used to make predictions, aggregate opinions about the likelihood of future events, or as preference indicators, identifying participants' product preferences. Participants in information markets buy and sell securities whose payoff is determined by unknown future event outcomes. The longest running real-money prediction markets are the Iowa Electronic Markets (IEM) at the University of Iowa. Traders submit market or limit orders for contracts representing the outcome of political elections. Those participants holding the winning contracts at the end of the market are rewarded based on the type of market.

An information market may generate a single measure, price, which represents the aggregation of all private and public information available to traders. The ability of markets to aggregate information is based on the Rational Expectations Theory. The strong form of the Rational Expectations Theory asserts that the sum total of all information available to participants in the market is instantaneously revealed in the price through the process of trading. In addition, participants learn information available to other traders, as reflected in price changes, and update their beliefs accordingly. As information is revealed, the prices reach a rational expectation's equilibrium. At this point, prices reflect all information available to all traders. Participants perform subsequent trades only if new information becomes available to the market participants.

However, there a number of aspects to information markets that makes them susceptible to manipulation. Since the market reflects the information currently known to the participating individuals, markets are responsive to the introduction of new information, whether accurate or not. In addition, markets have been observed to be robust to manipulation, bias, wishful thinking, and irrational behavior by the participants.

As will be appreciated by those skilled in the art, such information markets are, in fact, simply reflective of the performance of actual markets. Such markets might include financial markets, commodity markets, and so forth. Actual markets are also susceptible to manipulation, particularly by similar methods to those that might be modeled in information markets. Indeed, analysis via information markets is often useful in evaluating ways in which actual markets may be manipulated, and in similarly evaluating ways in which such manipulation may be detected and even prevented.

Therefore, a technique is desired that would reduce the effects of manipulation within a susceptible market. In particular, a technique is desired that would identify a potential manipulation within a market, and, once identified, that would allow for possible corrective actions to prevent the manipulation.

### BRIEF DESCRIPTION

A technique is presented for detecting manipulation in a market, such as a financial market, a commodity market, an information market, or any other market susceptible to manipulation. The technique utilizes a web-based market that enables a plurality of traders to trade, bid, purchase, sell, speculate or otherwise deal on an item. A record of each transaction between the traders of the market is stored. The transaction records are accessed and processed to identify transactions representative of a potential manipulation of the market. To identify a potential manipulation of the market, the transaction records are processed to identify transactions between a first trading account established by a trader and a second trading account established as an alias trading account. In addition, the transaction records are processed to identify transactions executed as part of a plan of collusion between two or more traders.

### DRAWINGS

These and other features, aspects, and advantages of the present invention will become better understood when the following detailed description is read with reference to the accompanying drawings in which like characters represent like parts throughout the drawings, wherein:

FIG. 1 is a schematic view of a market system having a system to identify potential manipulation of the outcome of the market, in accordance with an exemplary embodiment of the present technique;

FIG. 2 is a block diagram of a technique for identifying potential manipulation of a market, in accordance with an exemplary embodiment of the present technique;

FIG. 3 is a block diagram of a technique for identifying several types of manipulative behaviors in a market, in accordance with an exemplary embodiment of the present technique;

FIG. 4 is a detailed schematic view of a system for identifying potential manipulations of a market, in accordance with an exemplary embodiment of the present technique; and

FIG. 5 is a representative view of a product of the market manipulation detection system, in accordance with an exemplary embodiment of the present technique.

### DETAILED DESCRIPTION

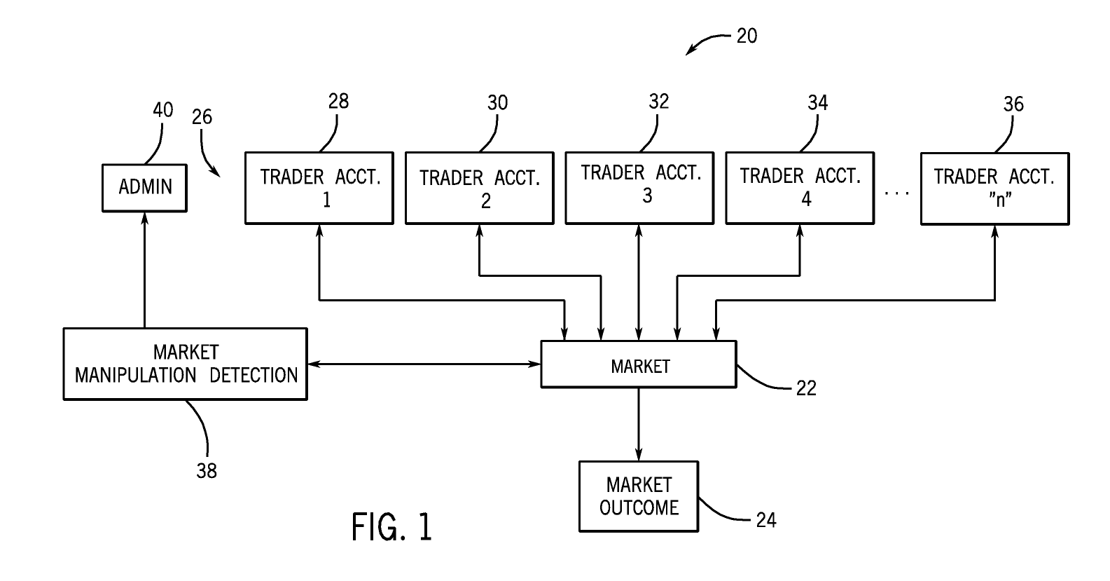

Referring now to FIG. 1, the present invention will be described as it might be applied in conjunction with an exemplary market, as represented generally by reference numeral 20. In this embodiment, the market is a financial market, and more particularly, an information market 22 adapted to produce an outcome 24 based on transactions executed between traders. The information market 22 is a network-based trading system where trades may be executed between traders for one or more transaction items using a network, such as the Internet. The transaction item may be the predicted value of a stock, a commodity, the estimated sales for a product, a predicted project completion date, the predicted opening weekend receipts for a Hollywood movie, the likelihood of an event occurring, or any other possible subject of a market. In general, however, it should be borne in mind that the present techniques may be used with any suitable market, including but not limited to financial markets, commodity markets, and further including both actual and information markets, prediction markets, actual and virtual stock markets, artificial markets, or idea markets and so forth. In this embodiment, the market outcome 24 is the volume-weighted average price of one or more transaction items during the five business days (or any desired period) prior to the information market 22 closing.

In the illustrated embodiment, traders make trades using trading accounts, as represented generally by reference numeral 26. The trader is able to open a trading account and choose the name of the trading account. The trading account names may be an e-mail address, the trader's name, or some other identifier selected by the trader. In the illustrated embodiment, there are a variable number of trading accounts associated with the information market 22. The total number of trading accounts used is determined by the number of trading accounts set up by the traders. In this embodiment, a first trading account 28, a second trading account 30, a third trading account 32, a fourth trading account 34, and the “nth” trading account 36 are presented.

A market manipulation detection system 38 is provided to identify potential manipulation of the information market 22. One definition of market manipulation is to take positions against one's own information or preferences to create price movements that will lure other investors and, ultimately, allow later profit. Market manipulation can, however, take many forms. For example, a trader may make trades that lose money in order to change prices and, therefore, change a policy. One tool for manipulating a financial market is through the use of a “sock puppet.” A sock puppet is a trading account set up by a trader using an alias to manipulate the market by giving the appearance of being a different trader. A “wash sale” is one type of market manipulation that may use such sock puppets. In such schemes, either through the use of one or more sock puppets or with the help of a collaborator, money is funneled from one trading account to another. As a result, one account may be sacrificed to achieve a financial gain in another. Another type of market manipulation is through “matched orders” or “pooling.” This involves buying and selling between sock puppets or collaborators to artificially inflate market statistics, such as the volume-weighted average price. Still another type of market manipulation is known as a “pumping and dumping.” In “pumping and dumping”, trading occurs between sock puppets or collaborators to create activity that will create interest in the stock, i.e., “pumping.” The increased interest results in the stock price increasing, at which point the dishonest trader or traders sell their stock at a profit, i.e., “dumping.”

As will be discussed in more detail below, the market manipulation detection system 38 maintains a database of trading activity and utilizes a computer-based application to identify potential manipulations of the market 22. When a potential manipulation of the market 22 is identified, the market manipulation detection system 38 informs an administrator 40 of the potential manipulation. In this embodiment of the technique, the administrator 40 makes the determination of whether the trading activity is an attempt at manipulation of the market 22 or if it is due to incompetence, bias, or some other type of behavior that may be unusual or even irrational, but is not manipulation. The administrator 40 also determines the appropriate action in response. However, an automatic mechanism may be used to take action whenever the market manipulation detection system 38 identifies a potential manipulation of the information market 22. For example, the market manipulation detection system 38 may block a trader identified as a potential manipulator from executing any more trades in the information market 22. Alternatively, all trading in the information market 22 may be blocked for an item in which an attempt at manipulation has been identified.

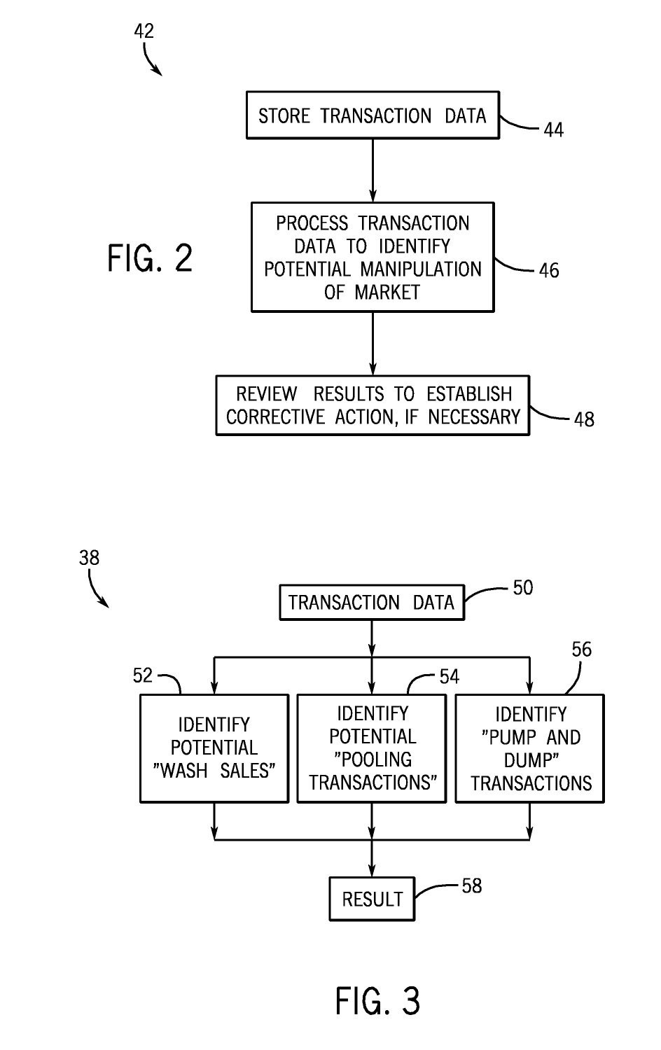

Referring generally to FIG. 2, a method for identifying potential manipulation of a financial market is presented, and represented generally by reference numeral 42. As with the system described above, the financial market is an information market adapted to produce a predicted market outcome based on transactions executed between traders. In general, however, it should again be borne in mind that the present techniques may be used with any suitable market that may be subject to actual or attempted manipulation.

In the illustrated embodiment, data associated with each transaction is stored, as represented generally by block 44. For example, the transaction data that is stored may comprise the item traded, the date and time of the trade, the trading account name of the buyer, and the trading account name for the seller for each transaction. Additional transaction data may be stored, if available. The transaction data may be stored in a database server, or some other device or system adapted to receive, store, and transmit data electronically.

The transaction data associated with each transaction is processed to identify potential manipulation of the market, as represented generally by block 46. For example, a computer may be programmed to process the transaction data and look for patterns of trading that are representative of manipulations of the market. Specifically, the program may be programmed to identify repeated trades between the same two trading account names. This would be evidence of sock puppet trading or collusion between two traders.

In this embodiment, the results of the transaction data processing are reviewed to establish whether further investigative action or a corrective action is necessary, as represented generally by reference numeral 48. The results of the data transaction processing may take many forms. The results of the data transaction processing may simply be a list of possible manipulators based on the programming by which the data is processed. For example, the results of the data transaction processing may simply state that the first trading account 28 and the second trading account 30 are potential market manipulators. However, the results of the transaction data processing may be more precise. For example, the results of the data transaction processing may be a list of trading account names that appear to be sock puppet accounts based on their transaction history. The appropriate transaction history may also be provided. Alternatively, the results of the data transaction processing may be a list of trading account names that appear to be engaging in specific types of market manipulations, such as wash sales, matched orders, or pumping and dumping. A responsible authority, such as an administrator, may take the appropriate action based on their review of the results. For example, the responsible authority may further investigate to determine whether a trading account is being used as a sock puppet or is part of collusion between two or more traders. Upon a determination that actual manipulation is occurring, the responsible authority can take the appropriate action to cease the manipulation, such as blocking the trader from further trading.

Referring generally to FIG. 3, a block diagram of the market manipulation system 38 is presented. In this embodiment, the trading behavior of traders is used to identify potential manipulations of the market 22. The trading behavior of the various traders is identified from the transaction records. The system 38 retrieves transaction data 50 and processes it to identify potential manipulations iof the market 22.

In the illustrated embodiment, the market manipulation detection system 38 is programmed to identify potential wash sales from the transaction data 50, as represented generally by block 52. The market manipulation detection system 38 also is programmed to identify potential matched orders or pooling transactions from the transaction data 50, as represented generally by block 54. The market manipulation detection system 38 also is programmed to identify pumping and dumping from the transaction data 50, as represented generally by block 56. In addition, the market manipulation detection system 38 provides the results of the various programs for review, represented generally by reference numeral 58.

The various programs of the market manipulation detection system 38 may be executed by one or more computer-based applications running on one or a set of computers. Indeed, the applications and the transactions may be performed in widely disparate systems, including systems around the world, and in particular systems linked to publicly or privately available exchanges. Moreover the processing and applications configured to identify manipulations may run in real time (i.e., as trades are logged, requested or made) or later (i.e., based upon records of trades). Similarly, the processing may be performed by exchanges themselves (i.e., on servers or computers operated by the exchanges) or by outsourced oversight analysts or even market regulators.

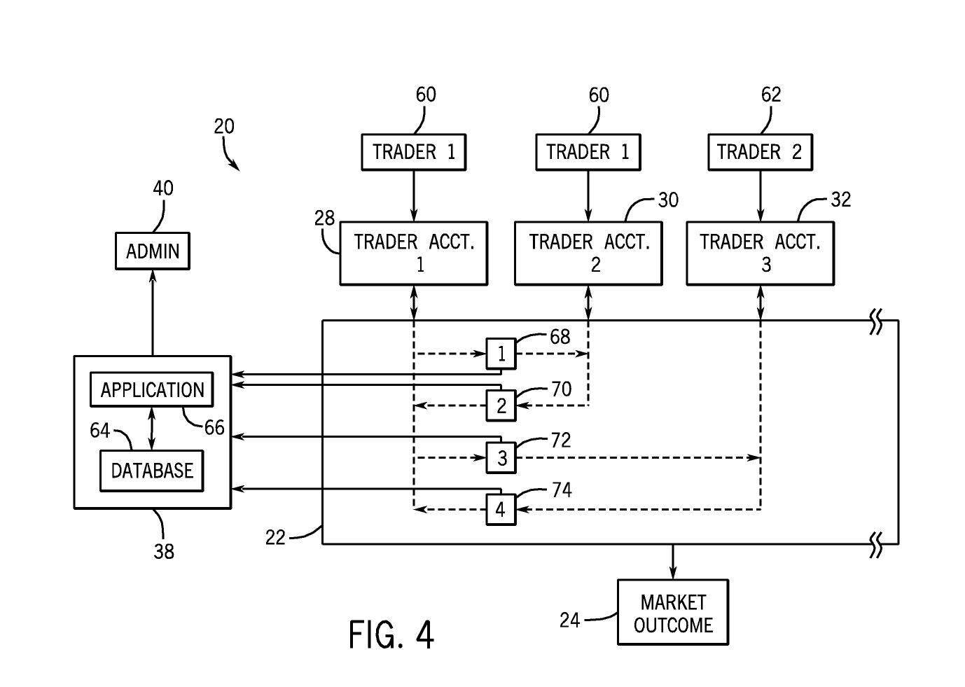

Referring generally to FIG. 4, a detailed embodiment of a financial market 20 having a market manipulation detection system 38 is presented. As will be discussed in more detail below, the market manipulation detection system 38 is adapted to identify patterns of trading that are representative of potential manipulations of the market.

In this embodiment, transactions executed under the first trading account 28 are directed by a first trader 60. In addition, transactions executed under the second trading account 30 are also directed by the first trader 60. This is an example of an alias or sock puppet account. Although the transactions are being executed by different trading account names, the same trader is directing the transactions. In addition, a second trader 62 executes trades using the third trading account 32.

A record of each transaction is stored in the market manipulation detection system 38. In this embodiment, the transaction data recorded in the market manipulation detection system 38 comprises the item transacted, the trading account name of the seller of the transaction item, the trading account name of the buyer of the transaction item, and the price of the transaction item. The transaction item may be anything tradable in a market, including actual and information markets, actual and virtual stock markets, prediction markets, and so forth. In the illustrated embodiment, the transaction data is stored in a database 64. The database 64 may be stored in a database server or some other electronic memory storage device or system, which may be centrally located or may include two or more disparate memory devices. The market manipulation detection system 38 also comprises at least one computer-based application 68 that processes the transaction data stored in the database 66 to identify potential manipulation of the market 22. The application is adapted to identify potential wash sales, potential pooled transactions, potential pumping and dumping, and other potential acts of attempted manipulation of the market 22.

In the illustrated embodiment, the first trader 60 is attempting to manipulate the market 22 by executing wash sales to funnel money between two accounts controlled by the first trader 60. In this embodiment, both the first trading account 28 and the second trading account 30 are controlled by the first trader 60. Thus, the second trading account 30 is a sock-puppet account of the first trader 60. The first sale is a first transaction 68 executed between the first trading account 28 and the second trading account 30. In this transaction, the first trading account 28 is selling the transaction item to the second trading account 30. A record of the first transaction 68 is stored in the database 64. A second transaction 70 also is executed between the first trading account 28 and the second trading account 30. However, in this transaction, the first trading account 28 is buying the same transaction item from the second trading account 30. For clarity, only a single example of each type of transaction is presented in FIG. 4, however, the first trader 60 may execute many trades between the two accounts.

In the illustrated embodiment, the first trader 60 also is attempting to manipulate the market 22 by engaging in collusion with the second trader 62. In this embodiment, the collusion between the first trader 60 and the second trader 62 also is to engage in wash sales to funnel money between the two traders. Here, a third transaction 72 is executed between the first trading account 28 and the third trading account 32. In this transaction, the first trading account 28 is selling the transaction item to the third trading account 32. A record of the third transaction 72 is stored in the database 64. A fourth transaction 74 also is executed between the first trading account 28 and the third trading account 32. However, in this transaction, the first trading account 28 is buying the same transaction item from the third trading account 32.

In this embodiment, the manipulation detection system 38 is adapted to identify wash sales regardless of whether the wash sales are occurring between sock-puppet accounts of the same trader or accounts of two different traders acting in collusion. In a wash sale, one trading account will gain cash, and then another trading account will lose cash. The trading account that gains the cash will be referred to as the “lion” account and the account that loses cash will be referred to as the “lamb” account. The trading pattern that is searched for in the trading history is four high volume trades on the same security: lion buys, lamb buys, lion sells, and lamb sells. When the lion buys, the value of the security increases. After the lion buys, the lamb, who is colluding with the lion, then buys. This causes the value of the security to increase even more. So far, the lion has bought low and the lamb has bought high. After being informed of the lamb's buy, the lion sells at this higher price and realizes a profit. This sell transaction causes the value of the security to decrease. At this point the lamb sells realizing a loss. The net effect of this is that the lion has successfully bought low and sold high while the lamb has bought high and sold low effectively transferring cash from the lamb's account to the lion's account.

The manipulation detection system 38 is programmed to detect this pattern of trading that is representative of wash sales. Once invoked, the application will interrogate trading data for this pattern and generate a report showing the supporting trading evidence so that an administrator can make a final decision and course of action. The more instances of this pattern of trading, the greater the evidence that a manipulation of the market is being attempted.

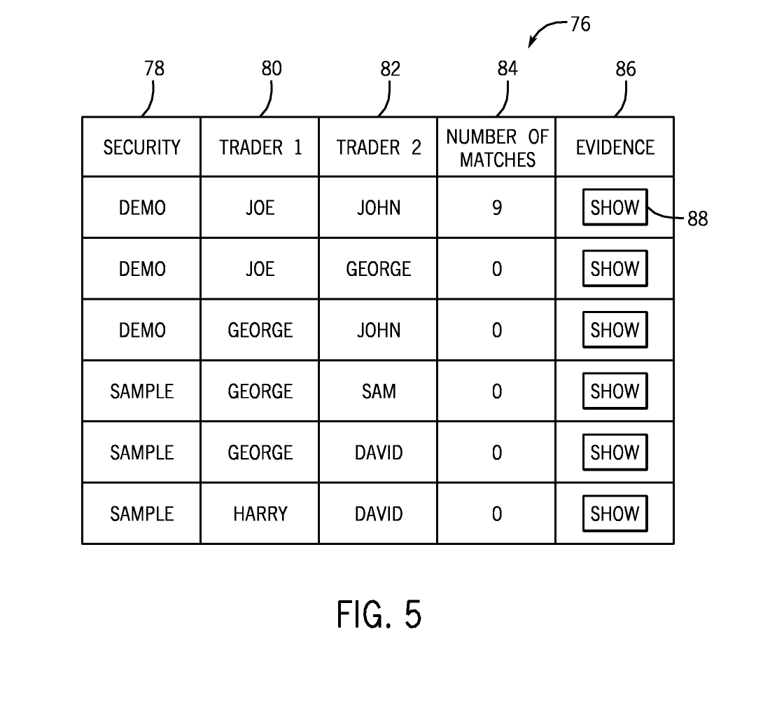

Referring generally to FIG. 5, an embodiment of a result produced by the manipulation detection system 38 for review by an administrator is presented, and represented generally by reference numeral 76. In this embodiment, the result 76 of the manipulation detection system 38 is the result of executing the manipulation detection system's program for detecting wash sales.

Each row of the result 76 represents trades for a specific security traded between two specific traders. The security traded between two traders is listed in a column 78. In addition, a column 80 is provided to list the name of a first trader and a column 82 is provided to list the second trader. In addition, the number of potential wash sales 84 between the two traders is provided. As noted above, the greater number the number of potential wash sales between the two traders, the greater the evidence that the trades are, in fact, wash sales. In addition, another column 86 is provided to enable the evidence of potential wash sales to be accessed by activating a virtual button 88. In this embodiment, when a row's virtual button 88 is activated the user is linked to the transaction data for all of the transactions between the two traders for that security.

The technical effect of the technique is to identify potential manipulations of a financial market. While only certain features of the invention have been illustrated and described herein, many modifications and changes will occur to those skilled in the art. It is, therefore, to be understood that the appended claims are intended to cover all such modifications and changes as fall within the true spirit of the invention.

1. A computer-implemented method for identifying a potential manipulation of a market, comprising:
accessing a plurality of records of transactions executed in a market; and
processing the plurality of records of transactions executed in the market to identify a transaction indicative of a potential manipulation of the market.

2. The computer-implemented method for identifying a potential manipulation of a market as recited in claim 1, wherein the market is network-based.

3. The computer-implemented method for identifying a potential manipulation of a market as recited in claim 1, wherein the market is an information market.

4. The computer-implemented method for identifying a potential manipulation of a market as recited in claim 1, comprising:
storing a record of each transaction executed in the market.

5. The computer-implemented method for identifying a potential manipulation of a market as recited in claim 4, wherein the record of each transaction executed in the market comprises at least one of:
an item traded in the transaction;
a trading account name for a first trader selling the item in the transaction;
a trading account name for a second trader buying the item in the transaction;
a trading price for the item traded in the transaction; and
a date and time that the transaction occurred.

6. The computer-implemented method for identifying a potential manipulation of a market as recited in claim 1, wherein processing the plurality of records of transactions comprises processing the plurality of records to identify collusion between a first trading account and a second trading account to manipulate the market.

7. The computer-implemented method for identifying a potential manipulation of a market as recited in claim 1, wherein processing the plurality of records of transactions comprises processing the plurality of records to identify wash sales between a plurality of trading accounts.

8. The computer-implemented method of for identifying a potential manipulation of a market as recited in claim 1, wherein processing the plurality of records of transactions comprises processing the plurality of records of transactions executed in the market to identify pumping and dumping transactions.

9. The computer-implemented method for identifying a potential manipulation of a market as recited in claim 1, wherein processing the plurality of records of transactions comprises processing the plurality of records of transactions executed in the market to identify transactions executed between a first trading account controlled by a first trader and a second trading account controlled by the first trader using an alias.

10. A computer-implemented method for identifying a potential manipulation of a financial market, comprising:
accessing a plurality of records of transactions executed in the market; and
processing the plurality of records of transactions executed in the market to identify a transaction between a first trading account controlled by a first trader and a second trading account potentially controlled by the first trader using an alias.

11. The computer-implemented method for identifying a potential manipulation of a financial market as recited in claim 10, wherein the market is network-based.

12. The computer-implemented method for identifying a potential manipulation of a financial market as recited in claim 10, wherein processing the plurality of records of transactions executed in the market comprises processing the plurality of records to identify a potential manipulation of the market between the first trading account and the second trading account.

13. The computer-implemented method for identifying a potential manipulation of a financial market as recited in claim 10, wherein processing the plurality of records comprises processing the plurality of records to identify wash sales between a plurality of trading accounts.

14. The computer-implemented method for identifying a potential manipulation of a financial market as recited in claim 10, wherein processing the plurality of records comprises processing the plurality of records of transactions executed in the market to identify pumping and dumping transactions.

15. The computer-implemented method for identifying a potential manipulation of a market as recited in claim 10, wherein the market is an information market.

16. A computer-implemented method for identifying a potential manipulation of a financial market, comprising:
accessing a plurality of records of transactions executed in the market; and
processing the plurality of records of transactions executed in the market to identify collusion between a first trading account and a second trading account to manipulate the market.

17. The computer-implemented method for identifying a potential manipulation of a financial market as recited in claim 16, wherein the market is web-based.

18. The computer-implemented method for identifying a potential manipulation of a financial market as recited in claim 16, comprising:
comparing trading account data to establish whether the first trading account and second trading account are controlled by the same trader.

19. The computer-implemented method for identifying a potential manipulation of a financial market as recited in claim 16, wherein processing the plurality of records of transactions comprises processing the plurality of records to identify wash sales between the first trading account and the second trading account.

20. The computer-implemented method for identifying a potential manipulation of a financial market as recited in claim 16, wherein processing the plurality of records of transactions comprises processing the plurality of records of transactions executed in the market to identify pumping and dumping transactions between the first trading account and the second trading account.

21. A computer-implemented method of operating a financial market, comprising:
establishing a network-based market that enables a plurality of traders to conduct transactions using the network-based market;
storing a record of each transaction between the plurality of traders;
accessing a plurality of records of transactions executed in the network-based market; and
processing the plurality of records of transactions executed in the network-based market to identify at least one transaction representative of a potential manipulation of the market.

22. The computer-implemented method of evaluating an item as recited in claim 21, wherein the market is an information market.

23. The computer-implemented method of evaluating an item as recited in claim 21, wherein processing the plurality of records of transactions comprises processing the plurality of records to identify a transaction between a first trading account controlled by a first trader and a second trading account potentially controlled by the first trader using an alias.

24. The computer-implemented method of evaluating an item as recited in claim 21, wherein processing the plurality of records of transactions comprises processing the plurality of records to identify collusion between a first trading account and a second trading account to manipulate the market.
